(19) United States
(12) Patent Application Publication
(10) Pub. No.: US 2011/0297597 A1
(43) Pub. Date: Dec. 8, 2011

(54) WATER VESSEL PROPELLED OIL SPILL RECOVERY SYSTEM AND ASSEMBLY

(76) Inventors: John Di Bella, Fort Lauderdale, FL (US); Alberto Di Bella, Fort Lauderdale, FL (US)

(21) Appl. No.: 13/153,951

(22) Filed: Jun. 6, 2011

Related U.S. Application Data
(60) Provisional application No. 61/396,914, filed on Jun. 4, 2010.
(60) Provisional application No. 61/396,913, filed on Jun. 4, 2010.
(60) Provisional application No. 61/399,545, filed on Jul. 14, 2010.

(51) Int. Cl. E02B 15/10; C02F 1/00; C02F 101/32

(52) U.S. Cl. 210/170.05

(57) ABSTRACT

An assembly and system for recovering spilled oil from water includes a water vessel such as a boat having a hull, a deck and vessel propelling means and a liquid gathering means and a water discharging means and a centrifugal liquid gathering and separating assembly mounted for separating oil from water and delivering separated oil into an oil retaining reservoir and delivering separated water into a water discharge conduit discharging the water back into the body of water. The liquid gathering and separating assembly includes an inlet end having a liquid gathering means preferably in the form of a skimmer to gather and receive unprocessed water from the body of water. The liquid gathering means can be in any location around the vessel.

### FILING HISTORY

This application continues from provisional patent application No. 61/396,914 filed on Jun. 4, 2010, provisional patent application No. 61/396,913 filed on Jun. 4, 2010, and provisional patent application No. 61/399,545 filed on Jul. 14, 2010,

### BACKGROUND OF THE INVENTION

1. Field of the Invention

The present invention relates generally to the field of systems and devices for recovering oil spilled into bodies of water. More specifically the present invention relates to a system and assembly for recovering spilled oil from water, including a water vessel such as a boat having a hull, a deck and vessel propelling means and a liquid gathering means and a liquid discharging means and a liquid gathering and separating assembly mounted onto one of the deck and the hull tunnel of the water vessel, or towed below the water surface by and adjacent to the water vessel for separating oil from water and delivering separated oil into an oil retaining reservoir and delivering separated water into a water discharge conduit discharging the water back into the body of water. The liquid gathering and separating assembly includes at its inlet end a liquid gathering means preferably in the form of a skimmer which can be of conventional construction, buoyantly supported in the surface of the body of water the vessel by a skimmer hose to gather and receive unprocessed water from the body of water. The liquid gathering means can be located in any location around the vessel, and the liquid gathering means and vessel need not be moving over the body of water to skim oil and water from the surface. Behind and in fluid communication with the liquid gathering means, preferably through the skimmer hose, is a liquid gathering conduit fitted with a water pump/impeller secured to the deck and drivably connected to a pump/impeller motor which draws gathered water into and through the liquid gathering conduit. Behind and in fluid communication with the liquid gathering conduit is a centrifugal liquid stratification and separation unit which includes a longitudinally extending liquid spinning tube containing impeller blades and spun by a blade motor which in turn spin the stream of gathered liquid at sufficient rotational speed to cause the liquid to radially stratify according to the specific gravities of its components so that water is thrown outwardly to the outside of the stream while the oil remains in an oil column extending along the central flow axis, and includes a separating manifold in the form of an oil gathering tube opening forwardly into the central axis of the tube and sized in diameter so that substantially all of the oil stratified at the center of the tube is driven into the oil gathering tube which leads to the oil retaining reservoir while the remainder of the stream consisting of water and its natural constituents flows out of the rearward end of the tube and back into the body of water. The reservoir preferably is mounted onto or is recessed into the vessel deck for ready access.

The second embodiment includes a water vessel such as a boat having a hull and vessel propelling means and an assembly mounting channel extending longitudinally within and through the vessel hull and opening out of the forward end of the hull, a liquid gathering and separating assembly mounted within the assembly mounting channel separating oil from water and delivering the separated oil into oil retaining reservoir and delivering the separated stream of water into a water discharge conduit delivering the water back into the body of water. The liquid gathering and separating assembly includes at its forward end a liquid gathering means opening forwardly out of the vessel, preferably in the form of a skimmer which can be of conventional construction directed forwardly from the vessel to gather and receive unprocessed water from the body of water. Behind and in fluid communication with the liquid gathering means is a liquid gathering conduit which passes gathered water into and through the liquid gathering conduit. Behind and in fluid communication with the liquid gathering conduit is a centrifugal liquid stratification and separation unit as in the first embodiment.

The liquid gathering and separating assembly preferably can be elevated within the assembly mounting channel for travel to and from an oil spill or storage site, and can be lowered within the assembly mounting channel for use, with assembly elevating means.

The stream of separated water, propelled by the separator impeller, preferably is either fixedly directed rearwardly or is passed from the tube through a pivoting flow directing conduit connected to a vessel steering mechanism which can be pivoted from one side to the other to also steer the vessel.

For a third embodiment, the water vessel functions as a buoyant structure preferably in the form of a water vessel such as a boat with separator support means which supports the separator in a position beside the buoyant structure just below the surface of a body of water where there is an oil spill.

The system of the third embodiment thus performs its separating function without bringing the majority of water drawn from the body of water aboard the boat or other buoyant structure, and preferably performs the separating function while the separator is underwater and thus without even lifting the water above the surface of the body of water, and the separated oil is pumped into a reservoir on the buoyant structure. Any centrifugal liquid gathering and separating assembly may be used. Separated oil is pumped into a reservoir on the buoyant structure.

The separator preferably is fastened to and extends downwardly from a separator mounting frame and the separator support means optionally includes Z-shaped deck brackets which fasten to the deck of the boat and extend down beside the boat to such an extent that the separator is submerged. Alternatively, the separator support means includes two deck mounted cranes, again so that the separator is submerged. The cranes are operated to lift the separator out of the water when the separator is not in use, to minimize drag as the boat moves. Still alternatively, the separator support means includes hydraulic or electric arm motors which pivot the separator upwardly and downwardly, again so that the separator can be pivoted into the water for use, and then pivoted out of the water when not in use to minimize drag.

The separator is configured to be secured such as by a customized Z-shaped bracket bolted on the surface of the boat with the separator below the water surface. As noted above, the water that enters the separator is separated into an aqueous stream and a concentrated oil stream. The aqueous stream is returned to open water without ever coming aboard the boat. The recovered oil stream is pumped to a retaining reservoir on the boat.

The liquid gathering and separating assembly preferably is as described for the first embodiment. The majority of the water drawn from the body of water never comes aboard the boat.

The liquid gathering and separating assembly preferably can be elevated within the assembly mounting channel for travel to and from an oil spill or storage site, and can be lowered off the side of the boat for use, with assembly elevating means.

The stream of separated water, propelled by the separator impeller, preferably is either fixedly directed rearwardly or is passed from the tube through a pivoting flow directing conduit connected to a vessel steering mechanism which can be pivoted from one side to the other to also steer the vessel.

2. Description of the Prior Art

It is thus an object of the present invention to provide a first embodiment of an oil spill recovery system and assembly which is mounted on a deck of a vessel and therefore can be fitted to virtually any boat, barge or ship.

It is another object of the present invention to provide such a system and assembly which separates and collects a high volume of oil from a slick on a body of water, and discharges separated water which is at least substantially free of oil.

It is still another object of the present invention to provide such a system and assembly which discharges separated water into the body of water from a vessel in a direction which propels or assists in propelling the vessel, and optionally having steering means which change the discharge direction to direct the vessel in desired directions.

It is yet another object of the present invention to provide such a second embodiment of a system and assembly which entirely prevents the water passing through the assembly from coming into contact with the deck or other parts of the boat so as not to contaminate the discharging stream of water.

It is a still further another object of the present invention to provide such a second embodiment a system and assembly which includes a centrifugal liquid stratification and separation unit, and in which the skimmed water and oil mixture is drawn through the system and assembly by the action of an impeller which is part of the separation unit which performs a centrifugal liquid separating function, so that no separate pump is needed and equipment and cost are minimized.

It is still another object of the present invention to provide a third embodiment of an oil recovering system and assembly which separates and collects a high volume of oil from a slick on a body of water, and discharges separated water which never comes aboard the boat and is at least substantially free of oil.

It is a further object of the present invention to provide such a third embodiment of a system and assembly which once again discharges separated water into the body of water from a vessel in a direction which propels or assists in propelling the vessel, and optionally having steering means which change the discharge direction to direct the vessel in desired directions.

It is a further object of the present invention to provide such a third embodiment of a system and assembly which once again entirely prevents the water passing through the assembly from coming into contact with the deck or other parts of the boat so as not to contaminate the discharging stream of water.

It is a further object of the present invention to provide such a third embodiment of a system and assembly which includes a centrifugal liquid stratification and separation unit, and in which the skimmed water and oil mixture is drawn through the system and assembly by the action of an impeller which is part of the separation unit which performs a centrifugal liquid separating function, so that no separate pump is needed to collect and draw the through the separator and equipment and cost are minimized.

Additional objects of the present invention are to provide such a third embodiment of the system and assembly which does not lift water from a body of water above the water surface as prior systems do, so that the system saves energy, whether in the form of electricity or fuel, is compact, can be stored on site, separates oil from water at a high volume and flow rate, is light in weight, and in which virtually any vessel can be used and in which the separator can be sized to match the size of the vessel.

It is finally an object of the present invention to provide such a system and assembly which is economical to manufacture, is highly and readily mobile and is easily used and maintained.

### SUMMARY OF THE INVENTION

The present invention accomplishes the above-stated objectives, as well as others, as may be determined by a fair reading and interpretation of the entire specification.

An assembly and system for recovering spilled oil from water is provided including a water vessel such as a boat having a hull, a deck and vessel propelling means and a liquid gathering means and a water discharging means and a centrifugal liquid gathering and separating assembly mounted for separating oil from water and delivering separated oil into an oil retaining reservoir and delivering separated water into a water discharge conduit discharging the water back into the body of water. The liquid gathering and separating assembly includes an inlet end having a liquid gathering means preferably in the form of a skimmer to gather and receive unprocessed water from the body of water. The liquid gathering means can be in any location around the vessel.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a cross-sectional side view of a boat having the liquid gathering and separating assembly mounted to the deck, illustrating the first embodiment off the system.

FIG. 2 is cross-sectional side view of an exemplary embodiment of the centrifugal liquid stratification and separation unit.

FIG. 3 is an aerial view of a body of water with two oil booms OB each being towed by a tow unit/vessel TU and between which an oil slick or portion thereof is contained, and a vessel as in FIG. 1 positioned to skim the oil from the slick and separate it and pump the oil into a reservoir in an oil containment barge OCB.

FIG. 4 is a cross-sectional side view of a boat having the assembly mounting channel containing the liquid gathering and separating assembly, illustrating the second embodiment of the system.

FIG. 5 is a front view of the boat of FIG. 4.

FIG. 6 is a perspective side view of a boat and separator illustrating the third embodiment of the system, where the separator is fastened to and extends downwardly from a separator mounting frame, and the separator mounting frame is secured to a side of the boat by Z-shaped deck brackets which fasten to the deck of the boat and extend down beside the boat to such an extent that the separator is submerged.

FIG. 7 is a view as in FIG. 6 except that the separator mounting frame is suspended from a side of the boat by cables extending from two deck mounted cranes, again so that the separator is submerged. The cranes are operated to lift the separator out of the water when the separator is not in use, to minimize drag as the boat moves.

FIG. 8 is a view as in FIG. 6 except that the separator mounting frame is supported at a side of the boat by two pivoting arms which are pivoted upwardly and downwardly by hydraulic or electric arm motors, again so that the separator can be pivoted into the water for use, and then pivoted out of the water when not in use to minimize drag.

FIG. 9 is a top perspective view of the separator mounting frame and attached separator.

FIG. 10 is a side perspective view of the separator mounting frame and attached separator as in FIG. 9.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

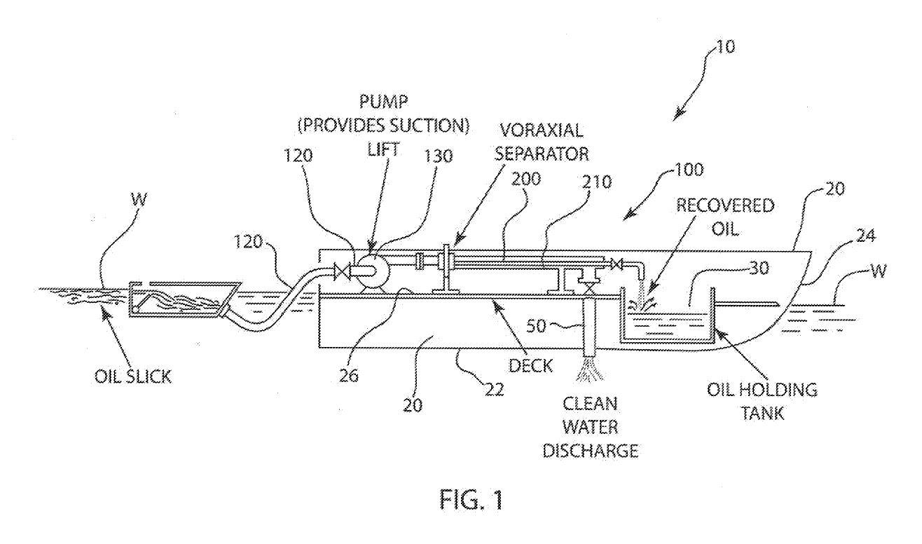

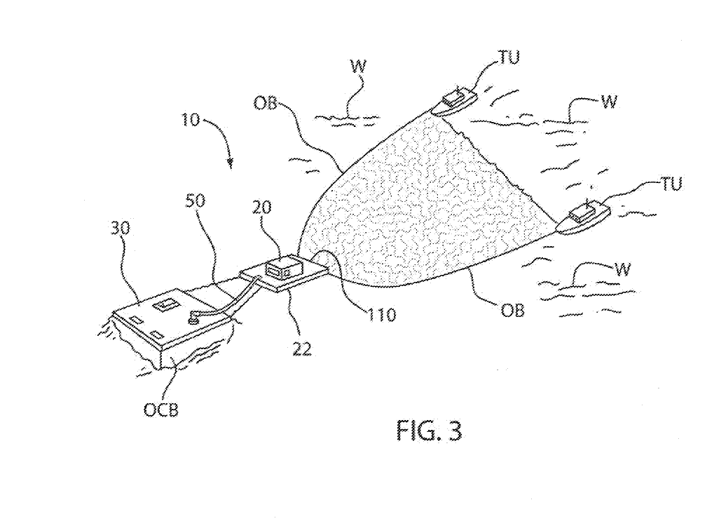

Referring to FIGS. 1-3, an assembly and system 10 for recovering spilled oil from water is disclosed, including a water vessel 20 such as a boat having a hull 22, a deck 26 and preferably a hull 22 and a bow 24, and vessel propelling means and a liquid gathering means 110 and a water discharging means 50 and a liquid gathering and separating assembly 100 mounted onto the deck 26 for separating oil from water and delivering separated oil into an oil retaining reservoir 30 and delivering separated water into a water discharge conduit 50 discharging the water through the hull 22 back into the body of water W.

The liquid gathering and separating assembly 100 includes at its inlet end a liquid gathering means 110 preferably in the form of a skimmer 110 which can be of conventional construction, buoyantly supported in the surface of the body of water W the vessel 20 by a skimmer hose 112 to gather and receive unprocessed water from the body of water W. The liquid gathering means 110 can be placed in any location around the vessel 20, and the liquid gathering means 110 and vessel 20 need not be moving over the body of water W to skim oil and water from the surface. Behind and in fluid communication with the liquid gathering means 110, preferably through the skimmer hose 112, is a liquid gathering conduit 120 fitted with a water impeller 130 secured to the deck and drivably connected to an impeller motor which draws gathered water into and through the liquid gathering conduit 120.

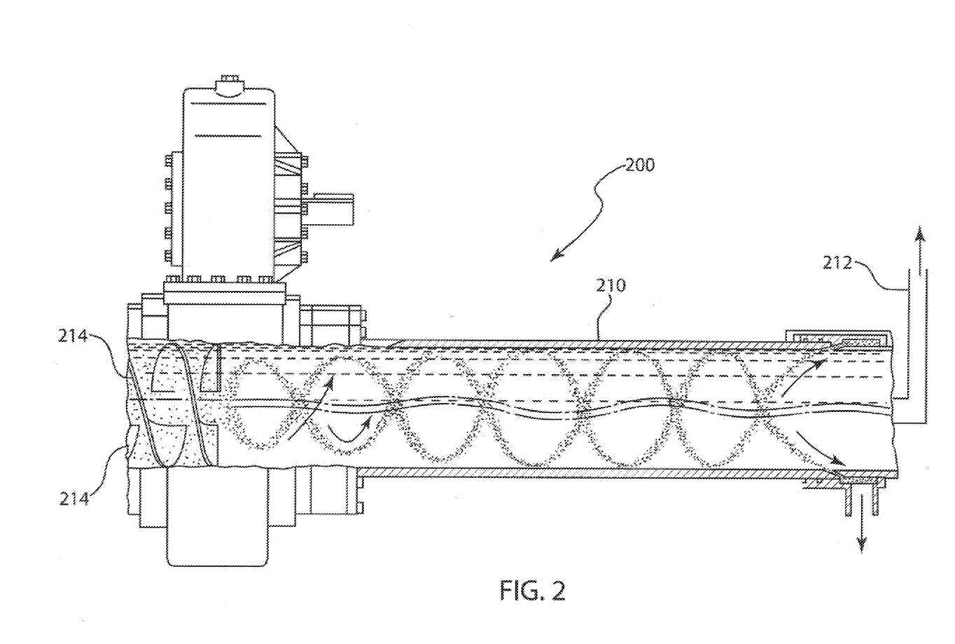

Behind and in fluid communication with the liquid gathering conduit 120 is a centrifugal liquid stratification and separation unit 200 substantially as disclosed in U.S. Pat. No. 6,248,231 and U.S. Patent Application Publication Number 2009/0176638 to the present applicant, the contents of which are incorporated by reference, which includes a longitudinally extending liquid spinning tube 210 containing impeller blades 214 and spun by a blade motor which in turn spin the stream of gathered liquid at sufficient rotational speed to cause the liquid to radially stratify according to the specific gravities of its components so that water is thrown outwardly to the outside of the stream while the oil remains in an oil column extending along the central flow axis, and includes a separating manifold in the form of an oil gathering tube 212 opening forwardly into the central axis of the tube and sized in diameter so that substantially all of the oil stratified at the center of the spinning tube 210 is driven into the oil gathering tube 212 which leads to the oil retaining reservoir 30 while the remainder of the stream consisting of water and its natural constituents flows out of the rearward end of the tube 210 and back into the body of water W through the water discharging conduit 50 preferably passing downwardly through the deck 26 and hull 22. See FIG. 2. The reservoir 30 preferably is mounted onto or is recessed into the vessel deck 26 for ready access. The vessel 20 may be barge which is therefore propelled by being towed such as by another vessel 20.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

### Second Preferred Embodiment

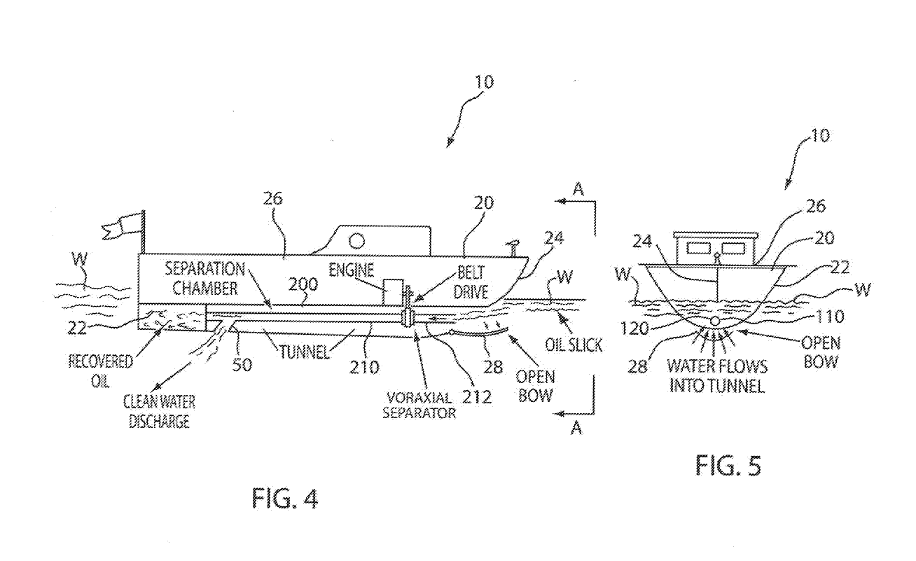

Referring to FIGS. 4-5, an assembly and system 10 are disclosed for recovering spilled oil from water, including a water vessel 20 such as a boat having a hull 22, a bow 24, a deck 26 and vessel propelling means 60 and an assembly mounting channel 40 extending longitudinally within and through the vessel hull 22 and opening out of the forward end of the hull 22, a liquid gathering and separating assembly 100 mounted within the assembly mounting channel 40 separating oil from water and delivering separated oil into an oil retaining reservoir 30 and delivering the separated stream of water into a water discharge conduit 50 delivering the water back into the body of water W. The liquid gathering and separating assembly 100 includes at its forward end a liquid gathering means 110 opening forwardly out of the vessel 20, preferably in the form of a gathering door 28 in the bow which pivots down to a generally horizontal position just below the water surface to skim the water and oil layer at the surface from the body of water. Alternatively a skimmer 110 which can be of conventional construction directed forwardly from the vessel 20 to gather and receive unprocessed water from the body of water W as the vessel moves forward. As a result of the pumping action of the impeller 130 and impeller blades 214 described below, however, water also can be gathered from the surface while the vessel 20 is stationary. Behind and in fluid communication with the liquid gathering means 110 is a liquid gathering conduit 120 which passes gathered water into and through the liquid gathering conduit 120. Behind and in fluid communication with the liquid gathering conduit 120 is a centrifugal liquid stratification and separation unit 200 substantially once again as disclosed in U.S. Pat. No. 6,248,231 and U.S. Patent Application Publication Number 2009/0176638 to the present applicant.

The stream of separated water, propelled by the impeller 130. preferably is either fixedly directed rearwardly to propel or to assist in propelling the vessel 20 through the water. Alternatively, the separated water is passed from the spinning tube 210 through a pivoting flow directing conduit 220 connected to a vessel steering mechanism (not shown) which can be pivoted from one side to the other to also steer the vessel 20.

The oil reservoir 30 preferably is recessed into the vessel deck 26 for ready access. The assembly mounting channel 40 preferably extends along the center of the vessel 20, that is, along the keel of a boat. The assembly mounting channel 40 can also be the space between pontoons where the vessel is a catamaran.

The liquid gathering and separating assembly 100 assembly preferably can be elevated within the assembly mounting channel 40 to minimize drag during travel to and from an oil spill or a storage site, and can be lowered within the assembly mounting channel 40 for use, with assembly elevating means (not shown).

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

### Third Preferred Embodiment

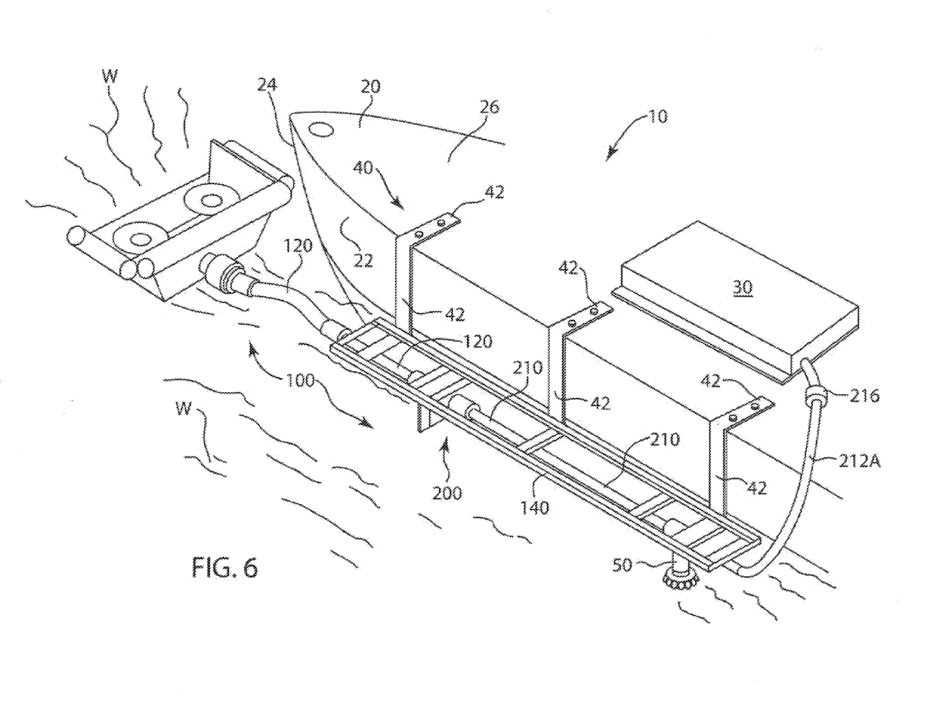

Referring to FIGS. 6-10, an assembly and system 10 are disclosed for recovering spilled oil from water, including a separator 100 in the form of a liquid gathering and separating assembly which separates oil from water and a buoyant structure preferably in the form of a water vessel 20 such as a boat with separator support means 40 which supports the separator 100 in a position beside the buoyant structure 20 just below the surface of a body of water W where there is an oil spill.

The system 10 thus performs its separating function without bringing the majority of the water drawn from the body of water W aboard the vessel or other buoyant structure 20, and preferably performs the separating function while the separator 100 is underwater and thus without even lifting the water above the surface of the body of water W, and the separated oil is pumped through an oil line 32 into a reservoir 30 on the buoyant structure 20. Any centrifugal liquid gathering and separating assembly may be used, but the preferred separator 100 includes a liquid gathering conduit 120 into which water and oil are drawn from the body of water W to form a substantially horizontal liquid column and is spun axially within a liquid spinning tube 210, such as with impeller means 130, so that the heavier water is thrown to the outer region of the horizontal liquid column while the lighter oil remains at the middle of the horizontal liquid column. Thus the oil and water are radially stratified, and the water is discharged from a water discharge conduit 50 opening from the side of the liquid spinning tube 210 and is returned to the body of water W, while the oil is drawn from an oil gathering tube 212 at the center of the liquid column and is pumped through an oil line 212A into an oil retaining reservoir 30 on the buoyant structure 20 which preferably is a boat 20 having a hull 22, a bow 24 and a deck 26.

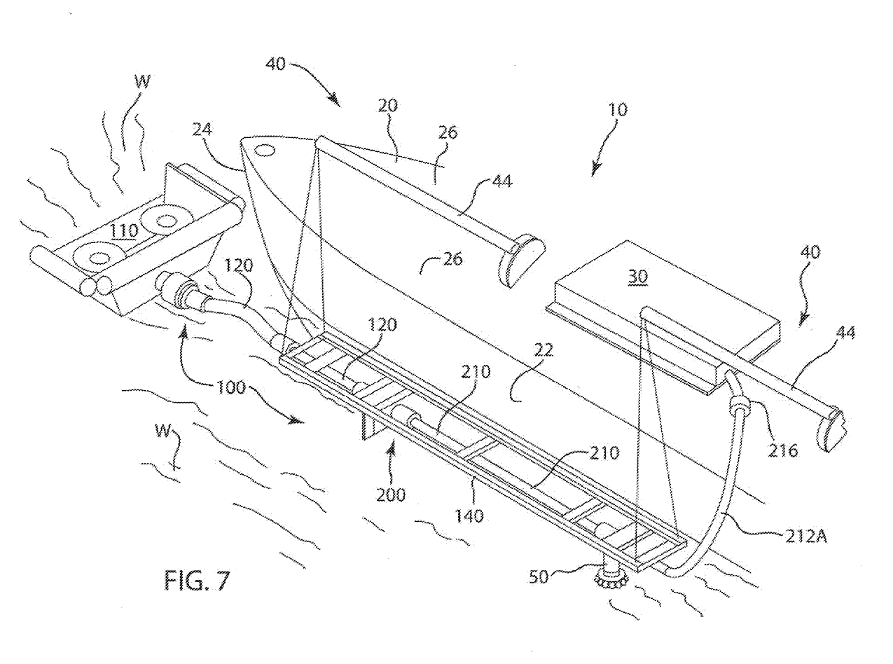

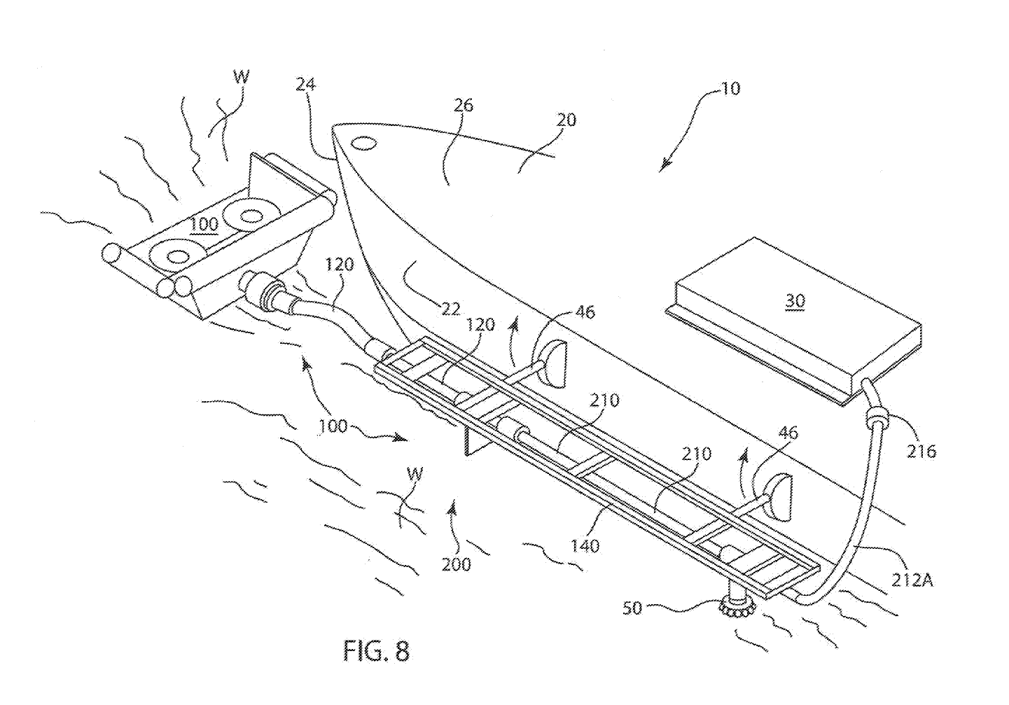

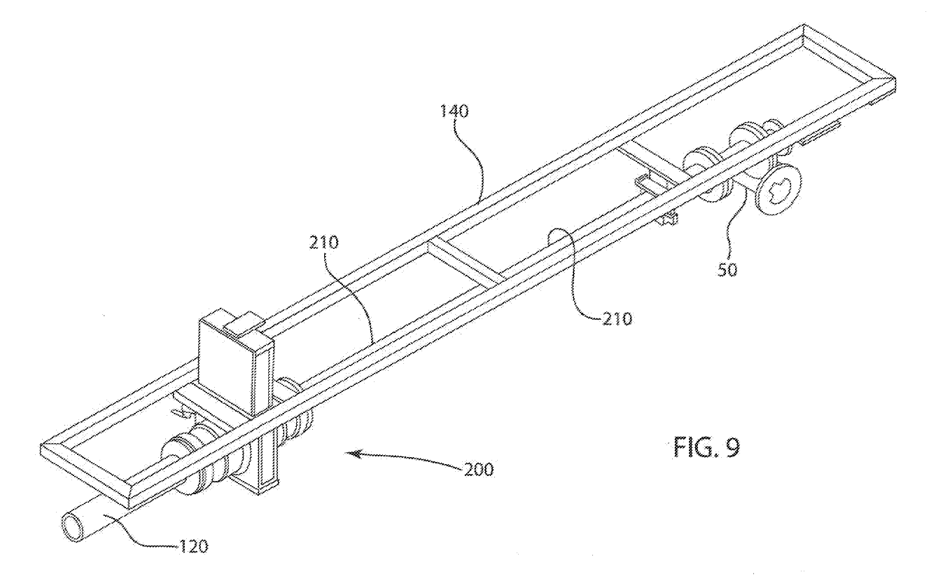

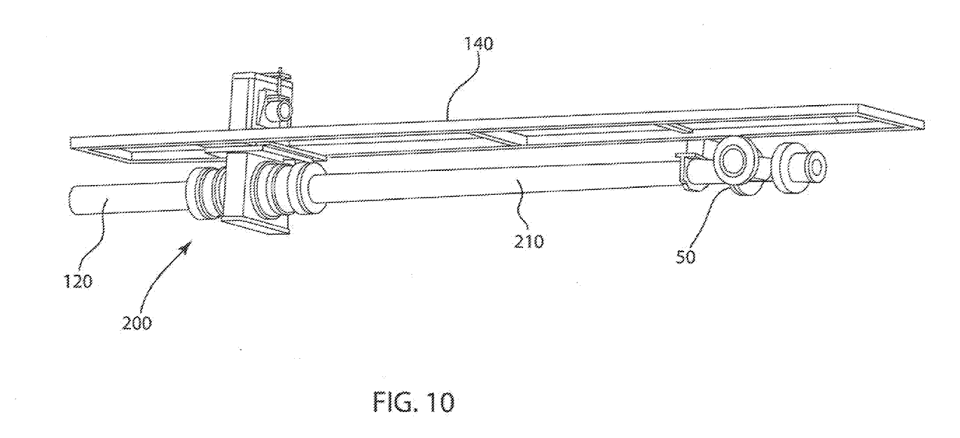

The separator 100 preferably is fastened to and extends downwardly from a separator mounting frame 140, as shown in FIGS. 9 and 10, and the separator support means 40 optionally includes Z-shaped deck separator anchoring brackets 42 which fasten to the deck 26 of the boat 20 and extend down beside the boat 20 to such an extent that the separator 100 is submerged, as shown in FIG. 6. Alternatively, the separator support means 40 includes two deck mounted separator lifting cranes 44, again positioning the separator 100 so that separator 100 is submerged, as shown in FIG. 7. The cranes 44 are operated in unison to lift the separator 100 out of the water when the separator 100 is not in use, to minimize drag as the boat 20 moves. Still alternatively, the separator support means 40 includes hydraulically or electrically powered separator lifting arms 46 which pivot the separator 100 upwardly and downwardly, again so that the separator 100 can be pivoted into the water and submerged for use, and then pivoted out of the water when not in use to minimize drag. See FIG. 8. A separator 100 may be provided and secured on both sides of a vessel 20, and it is further contemplated that multiple separators 100 may be provided and secured on one or both sides of the vessel 20. The separator 100 is preferably oriented parallel with the vessel 20 to minimize drag as the vessel 20 moves, but it is also contemplated that the separator 100 may be positioned in any other desired orientation relative to the vessel 20.

The separator 100 is configured to be secured such as by a customized Z-shaped bracket bolted on the surface of the boat with the separator 100 below the water surface. As noted above, the water that enters the separator 100 is separated into an aqueous stream and a concentrated oil stream. The aqueous stream is returned to open body of water W without ever coming aboard the boat 20. The recovered oil stream is pumped to a retaining reservoir 30 on the boat 20.

The liquid gathering and separating assembly 100 includes at its forward end a liquid gathering means 110 in the form of a skimmer 110, opening just below the water surface to skim the water and oil layer at the surface from the body of water W. Skimmer 110 preferably is of conventional construction directed forwardly beside the vessel 20 to gather and receive unprocessed water from the body of water W as the vessel 20 moves forward. As a result of the pumping action of the impeller 130 and impeller blades 214 described below, however, water also can be gathered from the surface while the vessel 20 is stationary. Behind and in fluid communication with the liquid gathering means 110 is a liquid gathering conduit 120, and behind and in fluid communication with the liquid gathering conduit 120 is a central portion of the separator 100 in the form of a centrifugal liquid stratification and separation unit 200 once again being substantially as disclosed in U.S. Pat. No. 6,248,231 and U.S. Patent Application Publication Number 2009/0176638 to the present applicant. The oil stream may contain some water. The remainder of the stream consisting of water and its natural contents found in the given body of water W flows out of the rearward end of the spinning tube 210 and back into the body of water W. The majority of the water drawn from the body of water W never comes aboard the boat 20.

Once again, the stream of separated water, propelled by the impeller 130. preferably is either fixedly directed rearwardly to propel or to assist in propelling the vessel 20 through the water. Alternatively, the separated water is passed from the spinning tube 210 through a pivoting flow directing conduit 220 connected to a vessel steering mechanism (not shown) which can be pivoted from one side to the other to also steer the vessel 20. The oil reservoir 30 preferably is recessed into the vessel deck 26 for ready access.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A system and assembly for recovering spilled oil from water, comprising:
a water vessel having a hull, a deck and vessel propelling means and a liquid gathering means and a water discharging means and a liquid gathering and separating assembly mounted onto said deck for separating oil from water and delivering separated oil into an oil retaining reservoir and delivering separated water into a water discharge conduit discharging the water through said hull back into the body of water.

2. The system and assembly of claim 1, wherein said water vessel is a boat.

3. The system and assembly of claim 1, wherein said liquid gathering and separating assembly comprises:
an inlet end having liquid gathering means buoyantly supported in the surface of the body of water said vessel by a skimmer hose to gather and receive unprocessed water from the body of water;
a liquid gathering conduit behind and in fluid communication with said liquid gathering means and being fitted with a water impeller secured to said deck and drivably connected to an impeller motor which draws gathered water into and through said liquid gathering conduit;
a centrifugal liquid stratification and separation unit behind and in fluid communication with said liquid gathering conduit and secured to said, deck, comprising a longitudinally extending liquid spinning tube containing liquid spinning blades spun by a blade motor which spin the stream of gathered liquid at sufficient rotational speed to cause the liquid to stratify according to the specific gravities, of its components, such that water is thrown outwardly to the outside of the stream while the oil remains in an oil column extending along the central flow axis;
and a separating manifold comprising an oil gathering tube opening forwardly into the central axis of said tube and sized in diameter so that substantially all of the oil stratified at the center of said tube is driven into said oil gathering tube which leads to said oil retaining reservoir while the remainder of the stream consisting of water and its natural constituents flows out of the rearward end of said tube and back into the body of water.

4. The system and assembly of claim 3, wherein said reservoir is one of mounted onto and recessed into said vessel deck.

5. The system and assembly of claim 3, wherein said wherein said liquid gathering means comprises a skimmer which can be of conventional construction.

6. A system and assembly for recovering spilled oil from water, comprising:
a water vessel having a hull and vessel propelling means and an assembly mounting channel extending longitudinally within and through said vessel hull and opening out of the forward end of said hull;
a liquid gathering and separating assembly mounted within said assembly mounting channel separating oil from water and delivering the separated oil into oil retaining reservoir and delivering the separated stream of water into a water discharge conduit delivering the water back into the body of water.

7. The system and assembly of claim 6, wherein said water vessel is a boat.

8. The system and assembly of claim 6, wherein said liquid gathering and separating assembly comprises:
an assembly forward end and a liquid gathering means at said assembly forward end opening forwardly out of said vessel, preferably in the form of a skimmer which can be of conventional construction directed forwardly from said vessel to gather and receive unprocessed water from the body of water;
a liquid gathering conduit behind and in fluid communication with said liquid gathering means and being fitted with a water impeller secured to said deck and drivably connected to an impeller motor which draws gathered water into and through said liquid gathering conduit;
a centrifugal liquid stratification and separation unit behind and in fluid communication with said liquid gathering conduit and secured to said deck, comprising a longitudinally extending liquid spinning tube containing liquid spinning blades spun by a blade motor which spin the stream of gathered liquid at sufficient rotational speed to cause the liquid to stratify according to the specific gravities of its components, such that water is thrown outwardly to the outside of the stream while the oil remains in an oil column extending along the central flow axis;
and a separating manifold comprising an oil gathering tube opening forwardly into the central axis of said tube and sized in diameter so that substantially all of the oil stratified at the center of said tube is driven into said oil gathering tube which leads to said oil retaining reservoir while the remainder of the stream consisting of water and its natural constituents flows out of the rearward end of said tube and back into the body of water.

9. The system and assembly of claim 6, additionally comprising assembly elevating means for elevating said liquid gathering and separating assembly within said assembly mounting channel for travel to and from an oil spill or storage site, and for lowering said liquid gathering and separating assembly within said assembly mounting channel for use.

10. The system and assembly of claim 6, wherein the stream of separated water, propelled by said impeller, is one of fixedly directed rearwardly and passed from said tube through a pivoting flow directing conduit connected to a vessel steering mechanism which can be pivoted from one side to the other to steer said vessel.

11. A system and assembly for recovering spilled oil from water, comprising:
a separator comprising a liquid gathering and separating assembly which separates oil from water and a buoyant structure preferably in the form of a water vessel with separator support means which supports said separator in a position beside said buoyant structure just below the surface of a body of water where there is an oil spill.

12. The system and assembly of claim 11, wherein said water vessel is a boat.
